(19) United States
(12) Patent Application Publication
(10) Pub. No.: US 2002/0152155 A1
(43) Pub. Date: Oct. 17, 2002

(54) Method for automated and integrated lending process

(76) Inventors: James E. Greenwood, Pottstown, PA (US); John H. Shain, Wayne, PA (US); Brian Blair, Malvern, PA (US); David E. Fusco, West Chester, PA (US); Karen Jorgenson, Coatesville, PA (US); Melissa Hofer, Pottstown, PA (US); Jerry Thompson, Media, PA (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/834,514

(22) Filed: Apr. 13, 2001

(51) Int. Cl. G06F 17/60

(52) U.S. Cl. 705/38

(57) ABSTRACT

An automated and integrated lending process for use by a financial institution is provided, comprising: a) a Sales Origination component; b) a Loan Accounting and Processing component; c) a Portfolio Management component; and, d) a network infrastructure utilizing thin client workstations and multiple servers to access the automated lending system via a browser capable interface.

### FIELD OF INVENTION

The present invention generally relates to automated financial service processes. More particularly, the present invention relates to a fully automated and integrated method by which a financial services institution can control and process all aspects of loan origination, accounting, billing and posting of payments and managing all critical information to portfolio management including all associated regulatory reports required by government agencies.

### BACKGROUND OF THE INVENTION

An important service provided by financial service institutions is the processing of loans; that is, money advanced to a borrower (obligor) to be repaid, in both principal and interest, at a later date or over a certain specified period of time. There are many different types of loans available. Some examples are: consumer loans, commercial loans, mortgages, and automotive loans.

The lending process involves a myriad of complex, manual processes, and many redundant, paper-based workflow tasks. Typically, when a potential customer (borrower (obligor)) interfaces with a financial or lending institution seeking a loan or information regarding a loan, this sets in motion a series of interrelated but separate processes, which have historically been handled on an ad hoc basis. Such ad hoc handling is inefficient, and wastes both time and money.

The conventional solution to processing different types of loans is to provide separate processes to perform accounting, billing, posting of payments, and portfolio management, including the generation of necessary reports. Given the level of competition in the financial services industry and the need to increase profitability management, reduce margin for error, and more closely manage the business, there is a need for a more standardized, sophisticated, and comprehensive process to streamline the entire lending process.

Application service providers (ASPs) are third-party entities that manage and distribute software-based services and solutions to customers across a wide area network from a central data center. An ASP can allow a user to access software via the Internet, for example, rather than having it reside on the user's hard drive. In essence, ASPs provide a way for companies to outsource some or almost all aspects of their information technology needs. However in order for an ASP to be effective in managing a financial service institution's lending needs, it must provide a process which compiles and monitor all information necessary for a loan, and which has means to analyze loan information and produce reports.

Studies have shown that on average lenders spend more than 50% of their time on administrative issues instead of calling on loan customers and potential customers. The majority of this administrative time is spent on gathering information for credit packages for new loans and renewals, waiting for approvals, and completing forms.

Accordingly, there exists the need for an automated and integrated process whereby financial institutions can outsource their lending needs to an ASP.

### SUMMARY OF THE INVENTION

The automated and integrated lending process of the present invention is a seamless, browser-based delivery process that fully automates and integrates the process of conducting a lending business through the real-time integration of collection of sales origination information, workflow automation, loan accounting and processing, and portfolio management. By providing a lending process through a single point of access, the present invention enables financial institutions to book, process, and manage any type of loan more efficiently at a lower cost per loan. The present invention utilizes a consistent base application infrastructure to leverage client's current network configuration and support industry standards and continuity.

There are three main components to the process of the present invention:

1. Sales Origination

The Sales Origination component 12 is the input or entry point for all necessary loan data to be used by the automated and integrated process of the present invention. The present invention comprises product standards to minimize the amount of data entry needed to produce documentation and book loans. As the information essential to process a loan is gathered and entered into the process, essential loan and customer data is replicated to other components of the process to eliminate redundant data entry and reduce errors.

Workflow process automation links the Sales Origination component 12 automatically through all areas of operations and accounting using image processing, that is, analyzing and manipulating images with a computer. Image processing eliminates paper exchange through fax, e-mail, etc., to increase data integrity and eliminate time-consuming tasks. The integration of credit scoring, statement analysis, and document preparation allows for automatic process decision making.

2. Loan Accounting and Processing

The integrated Loan Accounting and Processing component 14 of the present invention provides a single platform that supports all types of commercial and consumer loans, including, but not limited to: revolving lines of credit, small business loans, commercial real estate, middle market financing, large corporate loans, syndicated loans, letters of credit, asset-based loans, executive lines of credit, and dealer floor-planning. Loan information is entered into the process according to pre-set parameters, and exceptions are automatically logged and tracked.

The present invention is designed to offer flexibility in credit structure, pricing options, and the fee capabilities needed in today's global, Internet-paced environment. The essence of that flexibility is built on a implementation design, alleviating the need to re-execute work when lending terms change.

3. Portfolio Management

The Portfolio Management component 16 which performs as a combination of workstation software and professional services, enables management to identify revenue opportunities and cross-selling opportunities and to track and identify revenue leakage for either a particular customer or for a specific customer segment of a portfolio.

A multi-dimensional database permits drilldowns through the organization and the ability to stratify a lending portfolio by product, risk rating, industry, collateral, original credit size, non-performing status, vintage, and time period. Each multi-dimensional report can be viewed as a data grid or a chart, can be readily modified by the user and can be readily exported to a spreadsheet. User-defined calculations and sorting can also be applied to each report. Reports feature a variety of measures including period-end outstandings, average outstandings, total exposure, count, loan yield, fees and delinquency status.

Thus, the present process provides an automated and integrated lending process for use by a financial institution, comprising: a) a Sales Origination component; b) a Loan Accounting and Processing component; c) a Portfolio Management component; and, d) a network infrastructure utilizing thin client workstations and multiple servers to access the automated lending system via a browser capable interface.

In addition, a network infrastructure is provided utilizing thin client workstations and multiple servers to access the automated lending system via a browser capable interface.

### BRIEF DESCRIPTION OF DRAWINGS

The foregoing summary, as well as the following detailed description of the preferred embodiments, is better understood when read in conjunction with the appended drawings. For the purpose of illustrating the invention, there is shown in the drawings an embodiment that is presently preferred, in which like reference numerals represent similar parts throughout the several views of the drawings. It is understood, however, that the invention is not limited to the specific methods and instrumentalities disclosed. In the drawings:

FIG. 1 illustrates the overall combined process and automated workflow of the present inventions.

FIG. 2 depicts the network infrastructure and thin-client components of the application server delivery process of the present invention.

FIGS. 3A and 3B are flowcharts illustrating the processes used in the origination of loans as performed by the Sales Origination component 12 in FIG. 1.

FIG. 4 illustrates the processing required for the creation and ongoing maintenance of the loan portfolio within the Loan Accounting and Processing component 14.

FIG. 5 depicts the extraction of data from the Sales Origination component 12 and Loan Accounting and Processing component 14 by the Portfolio Management component 16.

### DETAILED DESCRIPTION OF PREFERRED EMBODIMENTS

The present invention is a software application service provider (ASP) which facilitates, through an embedded Internet address displayed as an icon via a local computer, a host of tasks and processes required to originate, book, service, and manage a loan portfolio. In a preferred embodiment of the present invention, the local computer is a thin client server having an Internet browser adapted to access the process of the present invention, as described in detail herein. The invention accommodates every type of loan that financial service institutions, also referred to herein as financial institutions, are known to create. The invention accomplishes this task by first establishing an efficient, fully automated and integrated workflow process that addresses every step and decision point made in conducting the duties of offering to make a loan, the production of the loan agreements and associated documents, the booking and account set up of the loan, account maintenance and servicing of the loan, and the exception and on-going management tools including a wide array of reports to manage the loan portfolio.

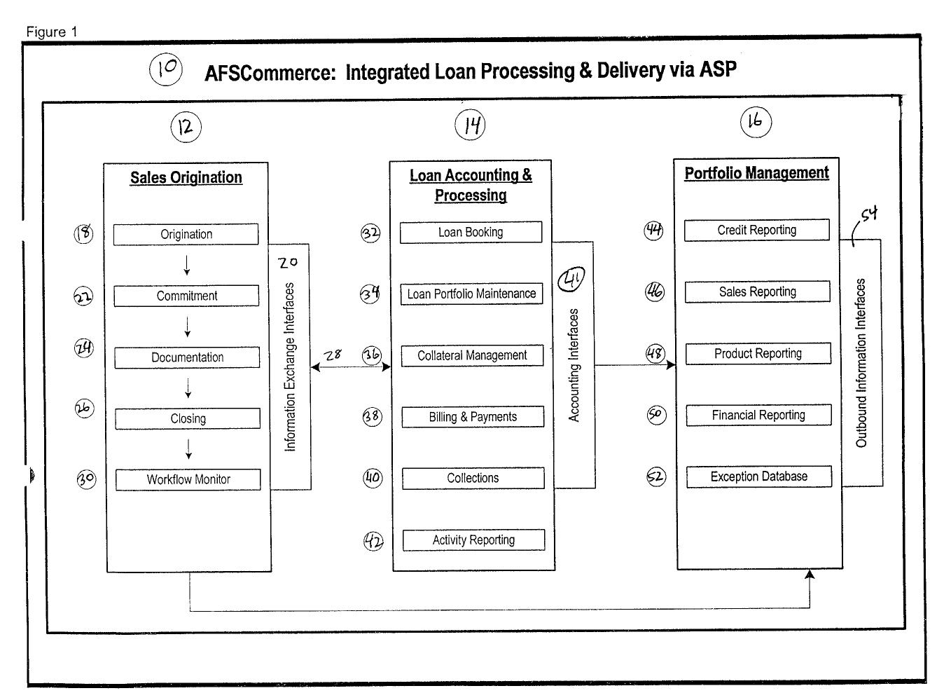

FIG. 1 shows a diagrammatic representation of the overall combined process of the present invention including automated workflow used in the application service of the present invention. Included in the overall workflow are the three main components of the invention: the Sales Origination component 12, the Loan Accounting and Processing component 14, and the Portfolio Management component 16. The process is installed as an all-in-one unit and operates as a combined unit from the point of initial installation.

Sales Origination

The workflow process begins with the Sales Origination component 12. Within this component are numerous interrelated modules. The Origination module 18 gathers the necessary data about the loan applicant and places it in a loan application record. Numerous factors impact the loan decision, that is, whether a loan will be granted or refused by a financial institution. These factors differ according to the type of loan. The process is designed to collect the information needed for processing each type of loan, as described in detail herein.

Financial information providers such as credit bureaus, credit scoring services, statement spreading packages and others are used by financial institutions to determine the credit history, credit obligations and financial performance about a prospective borrower (obligor). To perform the function of processing the loan origination data, the present invention comprises interactive Information Change Interfaces 20, as shown in FIG. 1, which interface with the financial information providers.

Once the information on the borrower (obligor) has been gathered and processed and a positive decision is made to grant a loan, appropriate commitment information is communicated to appropriate parties through the Commitment module 22. Commitment information generally comprises the terms and conditions under which a borrower will be repaying a loan. Commitment information is the information gathered during the application process, which allows the underwriter (lender) to understand the nature of the financial need, and determine the best loan type and amount to offer to the customer. To assist with the rapid and accurate gathering of the information, an underwriter checklist exists in the system that guides the underwriter in determining what additional documentation is needed to finalize the decision. The information place in the onscreen commitment document consists of data about the customer (name, address, etc.) and the business (financial statements, credit reports).

Entering commitment information into the Commitment module 22 generates applicable loan documentation in the Documentation module 24 and other paperwork required for further processing through the loan Closing module 26.

The loan Closing module 26 assembles all loan application information necessary to finalize the loan with the borrower. It should be noted that the process up to this point is completely “on-screen”—the process does not generate paper until the final stages of the loan closing process.

The Sales Origination component 12 has an interactive network link 28 with the Loan Accounting and Processing component 14. The interactive link 28 provides dynamic communication between the Sales Origination component 12 and the Loan Accounting and Processing component 14. Because it is common for a borrower to have had a loan history with the financial institution, the Sales Origination component 12 searches the file histories in the Loan Accounting and Processing component 14 via the bilateral link 28 for the loan history data in order to supply data required in the loan application, loan documentation, loan accounting process and other relevant records.

The Workflow Monitoring module 30 provides a means for monitoring supervisory information regarding the automated workflow process. Authorized managers, for example, may view the status of the loans in the workflow pipeline, determine workload of various staff members, and assign tasks related to the Sales Origination component 12 and process. The Workflow Monitoring module 30 also provides useful statistics for each loan application record such as number of days in the production pipeline, numbers of loans initiated during specific time periods, and other related information.

Loan Accounting and Processing

Loan Accounting and Processing 3 is the accounting work engine and the hub of the automated and integrated process of the present invention. Within the Loan Accounting and Processing component 14 are a variety of modules that manage all the tasks related to the creation and on-going maintenance of a loan portfolio.

The Loan Booking module 32 records the final agreed upon loan details into the loan application record including all details not only about the terms of the loan offered the borrower (obligor), but also details about the loan (obligation) including principal, interest, fees, and related loan information.

The Loan Portfolio Maintenance module 34 manages the on-going tasks related to the maintenance of loans and loan information. Some examples of maintenance tasks are changes of borrower address and changes in interest rates.

Collateral is routinely taken as security for most loans. The Collateral Management module 36 records the collateral information gathered during the sales origination process, records it in a loan obligation record, and monitors its location and/or status. In the case of negotiable collateral, values can be adjusted through the use of outside rating services. Third party credit rating services and other links such as connections to the financial institution's General Ledger records, Central Information File, and Treasury Department are all accommodated through bilateral Accounting Interfaces 41.

The Billing and Payments module 38 is included in Loan Accounting and Processing component 14. The Billing and Payments module 38 calculates and creates the bills, records the receipt of payments, and tracks any discrepancies between the bills and the payments.

The Collections module 40 provides the tools necessary for financial institution staff to record and monitor those loans which are not being paid as agreed to in the loan contract. Financial information about the loans including details on the principal, interest, and overdue fees as well as administrative tools designed to help staff make timely contact with the borrower are included in the Collections module 40.

All of the modules in Loan Accounting and Processing component 14 contain activities that must be monitored. The Activity Reporting module 42 assembles the information necessary for management to observe and track the activity, and appreciate the detailed status of the loan portfolio.

Portfolio Management

The management of a financial institution must also be able to track and analyze information about the loan portfolio in order to make decisions about sales activity, individual loan product viability, profitability, and quality of the portfolio. To accomplish this activity, specific details of loan portfolio data must be gathered, sorted and compiled to create the functional reports to facilitate the previous listed management duties. The Portfolio Management component 16 is the third major component of the present invention that provides these management reports.

The Portfolio Management component 16 is generally designed to extract and assemble data from the Sales Origination component 12 and Loan Accounting & Processing component 14, arrange the data in useful formats, and presents them as needed for review.

The Credit Reporting module 44 focuses on credit quality reporting. Information created by the Credit Reporting module 44 assembles data for portfolio managers and those involved in credit review to monitor credit problems, track industry exposure and understand risk migration patterns.

The Sales Reporting 46 module provides information for line managers who determine sales efforts, support cross selling activities, develop officer incentives, and improve customer profitability. The Sales Reporting module 46 allows financial institutions to address the on-going challenge of efficiently managing commercial customer relationships. The Sales Reporting module 46 allows both upper management and field level personnel to easily monitor their thousands of borrower relationships. It assists staff in evaluating, for example, the performance of borrowers, products, business units, and to support ongoing business strategies. As used herein, product can mean either a loan, a type of loan, or a services provided by a financial institution related to a loan.

Unlike most systems which present customer information at the product level only, the Sales Reporting module 46 ties all of the products and applications of the process used by a borrower together to provide an overall picture of the profit and loss relationship between the borrower and the financial institution. The Sales Reporting module 46 collects all relevant data from each relevant source, processes it into useful information and stores it at the ASP's data warehouse for computer access.

Output from the Sales Reporting module 46 is arranged in eight (8) categories:

1. Profitability Summary—product profit and total relationship contribution; return on equity, net interest margin.

2. Relationship Balance Sheet—loan commitment/outstanding; DDA (demand deposit account) ledger/collected balance; allocated equity.

3. Credit Income—interest income/expense; loan fees; loan loss provision; equity earning credit.

4. DDA Balance—led get balance; float; reserve; balance value.

5. Treasury Management/Deposit Service—product specific revenue/expense/contribution.

6. Demographics—customer contracts; DUNS umber; SIC; sales size.

7. Incentive Scorecard—product revenue; performance versus goals.

8. Analytical Tools—ranking; projections; relationship maintenance.

Users can retrieve the information they need on demand, via a browser. The process can present information in a wide array of formats, views, and hierarchies. The information is accessed on a web server and can be viewed the day it becomes available. The Sales Reporting module 46 uses a menu-driven format and point and click technology to make it easy to get the information. Routine reports are pre-packaged for easy viewing online. Ad hoc or specialized reports can be created. Standard reports may be automatically generated on a regular monthly basis. The data can also be viewed on a product line basis thus allowing the financial institution to change sales strategy on a specific product, recognize a cross-sale opportunity, change strategy on which customers to pursue for specific products. Customer and product trends can be readily observed

A financial institution can also use the process to improve performance by setting standards for incentive programs and marketing campaigns based on report results in the Sales Reporting module 46.

The Product Reporting module 48 reviews various loan products that have been extended and helps financial institution managers optimize price and revenue from loan product lines. The Product Reporting module 48 is designed for use by large financial institutions with massive cash management lines of business to manage. Large financial institutions universally have the problem of trying to provide management with relevant information to run the cash management business line that is a product offered to commercial clients.

The Product Reporting module 48 takes raw data from account analysis, competitive data, cost information and other sources and consolidates it into a single source.

Output from the Product Reporting module 48 is arranged in six (6) categories:

1. Profitability—product/market performance; performance vs. goals; product/market ranking.

2. Product Usage—customer penetration; cross usage; usage trends.

3. Exception Pricing—exception levels by market, product and Relationship Manager (RM).

4. Price Change Management—product modeling; proposed prices; RM exception review.

5. Customer Profiles—customer and customer segment views of product volume/revenue/margin and balance/rate data (ECR, Overdraft Interest).

6. Revenue Initiative Tracking—benefits attained and potential revenue opportunities associated with AFS revenue enhancement initiatives.

The Product Reporting module 48 relieves the financial institution of the burden of dealing with large, disparate legacy systems used to gather information. Users can retrieve the information needed on demand via a browser, in a wide array of formats, views and hierarchies. The data is formatted in a Question and Answer format designed for real-world business issues and provides management with accurate views addressing matters of performance, sales and marketing, product management and more. Routine reports are pre-packaged and ad hoc or specialized reports are readily developed with minimal training.

The Financial Reporting module 50 extracts information about loan rates that have been extended and other data such as check management which impacts the revenue of the financial institution. The Financial Reporting module 50 combines product revenue with payment processing revenue to allow financial institution management to manage accounts and extract the utmost in revenue from the relationship with the borrower. By reducing financial institution float, optimizing clearing methodology and reducing processing costs, improving processing efficiencies and capturing information about the composition of deposits, and processing times, the financial institution can optimize customer profitability.

Users can retrieve the information needed on demand via a browser, in a wide array of formats, views and hierarchies. The data is formatted in a Question and Answer format designed for real-world business issues and provides management with accurate views addressing matters of performance, processing, customer segments, product management and more. Routine reports are prepackaged and ad hoc reports are readily developed with minimal training.

The Exception Database module 52 tracks information about various types of exceptions that occur during the lending process. By focusing on price, risk, collateral and documentation, the Exception Database module 52 arrays information in such a manner that management can easily determine whether loans are being priced appropriately, shows areas of risk such as high concentration levels (e.g. industry types, collateral types, individuals, companies, etc.), notes where loans have been under-collateralized, and indicates any negative trend in documentation errors.

The Portfolio Management component 16 is capable of interfacing with other components and processes of the present invention. Unlike the Sales Origination component 12 and Loan Accounting & Processing component 16 interfaces, the Portfolio Management component 16 interface is a one way Outbound Information Interface 54. The Outbound Information Interface 54 data from various reports produced and the Exception Database 52 can be formatted for use by a variety of applications such as word processing programs, spreadsheet programs, accounting programs, imaging programs, or other formats.

Network Infrastructure

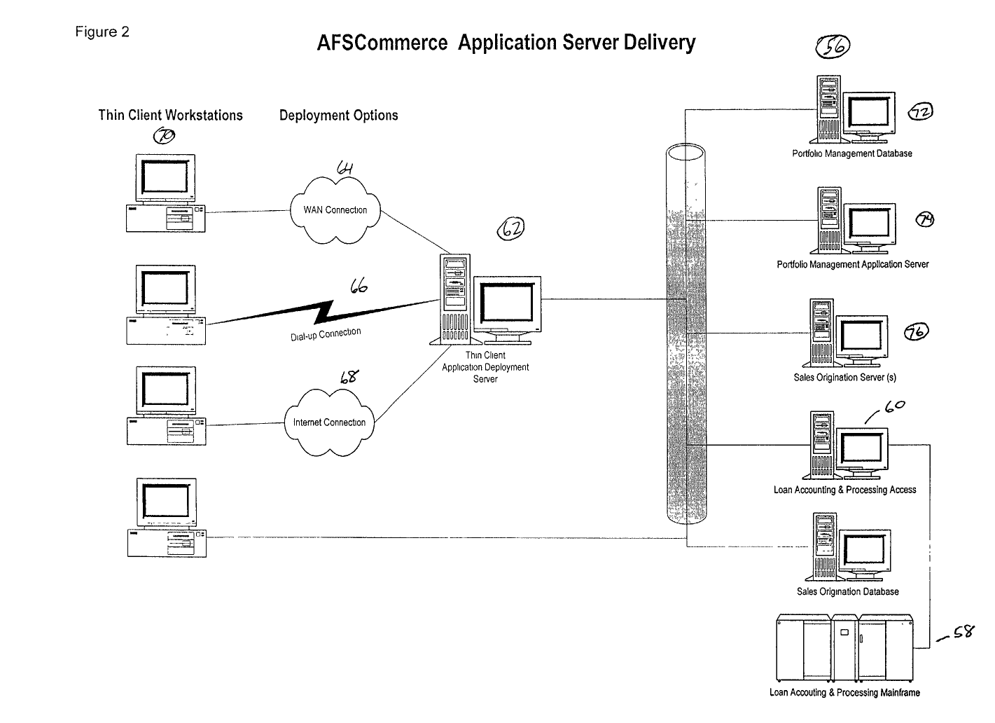

As part of the process of the present invention, technology is included to deliver the business processes. A detailed description of the delivery structure is provided with reference to FIG. 2.

The present invention provides a network infrastructure designed to be functional, redundant, and high performing. The network is designed is to provide end-users a predictable and reliable interaction with the applications. The design and deployment methodologies minimize major infrastructure enhancements on the part of the financial institution clients.

FIG. 2 represents a depiction of the connection from the financial institution's locations to the ASP components of the present invention. A series of servers, or server tier 56, contain the databases and applications software required to handle the three major components of the present invention: Sales Origination 12, Loan Accounting and Processing 14, and Portfolio Management 18.

The Loan Accounting and Processing component 14 runs on an application server 58 and it is used in combination with a Loan Accounting and Processing access server 60. These various servers 56 communicate to the Thin Client Application Deployment Server 62. The Thin Client Application Deployment Server 62 communicates to a financial institution by one of three deployment options: Wide Area Network (WAN) 64, Dial-up Connection 66 or Internet Connection 68. The deployment methodology connects directly to each of the financial institution's individual thin client workstations 70.

Modifications to the application service screens and associated content can be made once at a central location, then disseminated simultaneously to all the thin client workstations 70.

The server tier 56 comprises many servers that facilitate both dedicated and shared services for clients utilizing the present invention. The server tier 56 additionally comprises: a portfolio management database 72; a portfolio management application server 74; and, a sales origination server or servers 76.

All servers are configured to be fault tolerant. Each server is equipped with a minimum of two processors or more, dual power supplies, dual disk array controllers, and dual network interface cards. Additionally, each server is duplicated in the environment via mirroring, data replication, or hot spare. Server configuration and data segmentation is facilitated to ensure that each client accesses the applications in a secure manner.

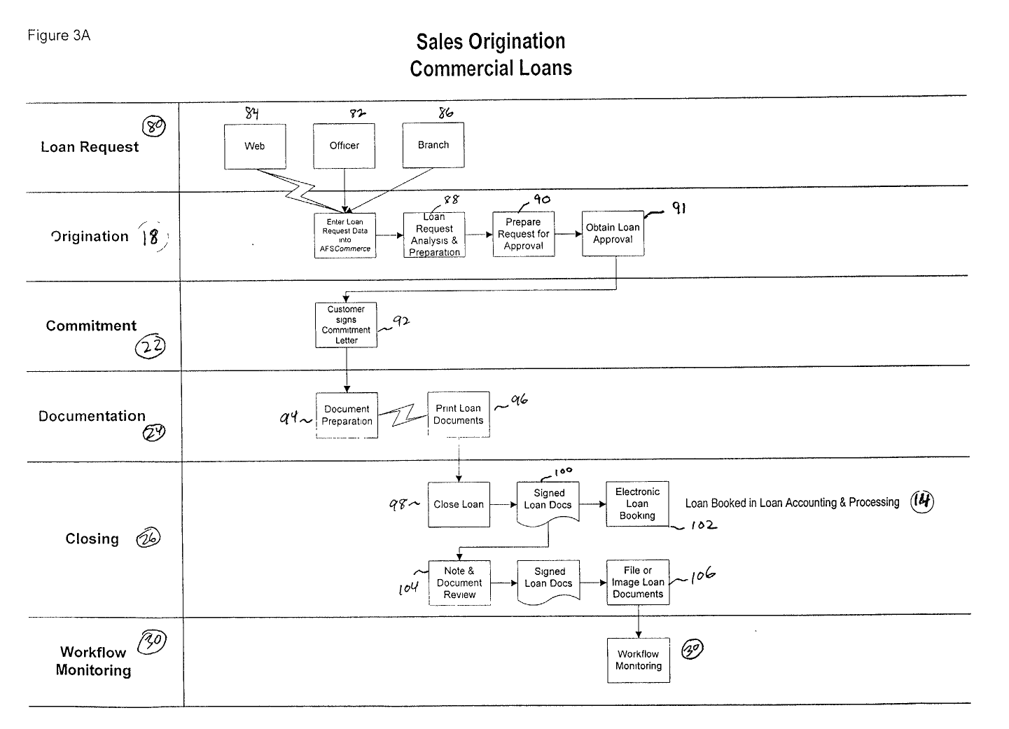

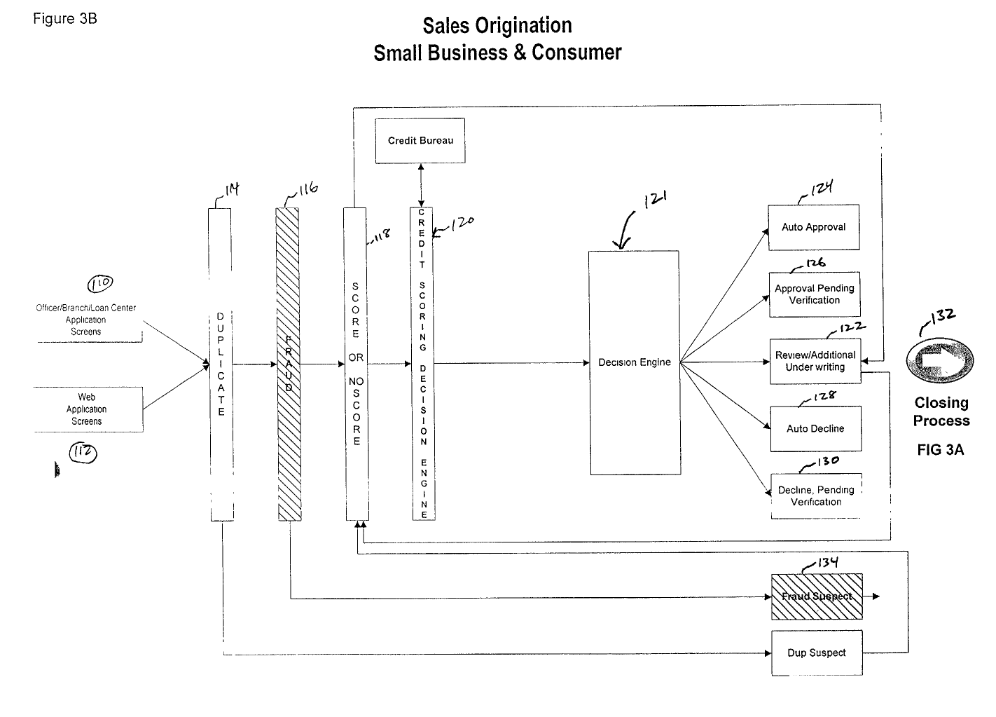

The technology described above supports the delivery of the process provided by the present invention. A detailed description of the major components of the process, Sales Origination 12, Loan Accounting and Processing 14 and Portfolio Management 16, introduced above will now be provided with reference to FIGS. 3-5.

Referring now to FIGS. 3A-3B, there is illustrated a representation of the processes incorporated in the Sales Origination component 12. In general, loan sales origination processes are generally similar, except that fewer steps are necessary for processing consumer and certain types of small business loans than for commercial loans. Commercial loans are generally more complicated than consumer loans, thereby creating different loan structures to accommodate specific types of funding needs. Extensive information is required to make the commercial loan decision including, but not limited to, the financial condition of the borrower, the financial condition of industry, the financial condition of the borrower's management, and other economic issues that affect the borrower.

Consumer loans have fewer elements to be considered in order to make a loan decision. Success of repayment of a consumer loan can be predicted by rating various factors related to the borrower. Accordingly, consumer loans are granted based on an automated decision/credit scoring process. Small business loan repayment success shares many predictors used in consumer loan scoring. This has led to the application of the consumer loan automated decision/credit scoring process to small business loans, thus eliminating the need to conduct extensive credit approval analysis.

The processes used in the Sales Origination component 12 therefore reflect these different approaches to determining creditworthiness, which leads to the grant of or refusal to grant a loan. FIG. 3A depicts the Sales Origination process for commercial loans.

A loan officer 82 most frequently receives the loan request 80 but it is appreciated for the purposes of the present invention that one can also be received by web inquiry 84 or through the financial institution's branch process 86. Information gained from the loan request 80 is gathered into the Origination module 18 where basic data is recorded about the loan request 80 and the borrower.

The Loan Request Analysis & Preparation step 88 includes the process of spreading the borrowers financial statements, analyzing the trends and financial condition of the borrower, ordering and evaluating information on a credit bureau report, and conducting credit inquiries with existing lenders and trade credit grantors.

The information assembled from the Loan Request Analysis & Preparation step 88 is evaluated, compiled, and formally presented as a request for approval generated in the Prepare Request for Approval step 90. Loan applications are received most commonly by direct contact with a financial institution's loan or branch officer, but could also be conveyed by phone, or through web application screens. The system leads the person receiving the loan origination information, or the loan originator, through a series of screens to collect pertinent application information based on specifics of the loan. Any deficiencies in the application must be resolved before it can be submitted for further processing. Information is consolidated, placed in an appropriate format either electronically or in hard copy format, and conveyed to those who have the authority to approve the loan. The types of information required range form name and address, type of business, financial statement information, amount and type of loan desired, through to other documents such as business plans and personal financial statements for the principals of the business.

The next step is to Obtain Loan Approval 91. In this step, the loan application is forwarded to the appropriate staff for approval based on criteria established by the financial institution's lending policy. Approval processes in financial institutions vary by organization but can generally be categorized as either a committee system or by signature approval. Committees consist of a group of experienced lenders, usually chaired by the head of the lending or credit group, who confer regarding the merits of the application and vote on whether to approve the loan. Signature systems generally operate by giving signing authority to most if not all commercial lenders in the financial institution. The authorities vary by dollar amount. Therefore, it is up to the lender in charge of the loan to obtain sufficient numbers of signatures whose total authorities collectively exceed the total amount of the loan. An alternative approach is to obtain signatures proceeding up the financial institution's hierarchy of signing authorities until the final signature obtained has authority to grant the total loan amount. Regardless of the approval method, the process of the present invention conveys the loan application to the required financial institution personnel to review the loan approval.

Once approval has been obtained the loan information moves to the Commitment module 22, where a commitment letter 92 is prepared stating the key components of the loan commitment.

Once the commitment letter is signed by the borrower (obligor), appropriate documentation are prepared in a Document Preparation step 94. The documents prepared containing the details of the loan to be agreed upon by the borrower is prepared and printed during the Print Loan Documents step 96. The printed documents are signed at the Close Loan step 98. Because of the sophisticated nature of commercial loans it is common to have last minute negotiations take place during the closing process. This results in changes of condition within the loan agreement.

Once the loan documents are signed 100 the documents are sent to a separate area for review for completion and simultaneously the loan is booked in an Electronic Loan Booking step 102 in the Loan Accounting & Processing component 14. The Electronic Loan Booking step 102 automatically books the borrower, obligation, collateral, and guarantors to the lending system. The Electronic Loan Booking step 102 includes recordation of all the details of the loan: term, amount, interest rate, payment schedules, and other related information.

The information pertaining to the loan documents are then reviewed during the Note & Document Review step 104. Document parameters are established within the system for every type of loan the financial institution will grant. These parameters specify each document necessary to adequately record, and secure the financial institution's position. The Note & Document Review step 104 ensures that the correct documents are received, reviews the received documents for proper execution, and records exceptions for issues or follow up items. These documents include the note as well as documents necessary to protect security interests. During this step, exceptions may be noted for later entry into the Exception Database 52. Any loan document exceptions that have been noted are sent to the Exception Database 52 which is housed in the Portfolio Management 16 component.

Once the loan documents have been reviewed and the exceptions noted, the signed documents are sent to the institution's files or imaged in their file imaging system during the File or Image Loan Documents step 106. The process is totally image enabled. A vendor imaging system is integrated into the process. All documents related to the loan can be imaged and stored for reference during the life of the loan. Examples of documents included are the loan note, corporate financial statements, UCC filings, management information, and business plans among other items

As discussed above, the Workflow Monitor module 30 provides a means for monitoring supervisory information regarding the automated workflow process.

The steps in the process of Small Business and Consumer Sales Origination are depicted in FIG. 3B. As noted earlier, fewer steps are involved for these types of loans. The Small Business and Consumer Sales Origination process substitutes credit scoring for the manual loan, credit analysis and evaluation stages present in commercial lending.

Credit scoring is a system creditors use to help determine whether to give you credit. Information about a borrower and a borrower's credit experiences, such as bill-paying history, the number and type of accounts maintained, late payments, collection actions, outstanding debt, and the age of your accounts, is collected from your credit application and your credit report. Using a statistical program, creditors compare this information to the credit performance of consumers with similar profiles. A credit scoring system awards points for each factor that helps predict who is most likely to repay a debt. A total number of points—a credit score—helps predict how creditworthy a borrower is, that is, how likely it is that a borrower will repay a loan and make the payments when due.

Loan applications are received via several sources: by phone to loan centers and financial institutions 110, web application screens 112, or through direct contact with a loan officer or branch officer. The Sales Origination component 12 of the present invention is designed to accommodate all of these sources.

The first step within the origination process is to check for duplicate loan applications during the Duplicate step 114. Once verified that no duplicates exist, the application then proceeds through a fraud identification step 116. Those loan applications that are suspected as fraudulent due to misrepresentation of loan application data submitted by the prospective borrower are analyzed by the process of the present invention. Fraud suspect loan applications are transmitted to a fraud identification service. If no flags for suspected fraud are found, then the loan application is forwarded to the score/no score decision engine and proceeds through the process.

Having survived the Duplicate step 114 and the fraud identification step 116, the loan application record reaches a Score or No Score decision engine 118. The financial institution will set criteria on the type of loans it wishes to score and those that should not be scored. Loans will be separated at this point based upon the criteria set by the financial institution. Loans that will not be scored are routed through the commercial loan steps depicted in FIG. 3A.

Loans to be scored will be forwarded to the Credit Scoring Decision Engine 120. From the Credit Scoring Decision Engine 120, the loan application may be forwarded to the Review/Additional Underwriting step 122. The loan application information will be compared to the financial institution's criteria regarding the need for review or additional underwriting information. An example of additional underwriting information would be the need for further financial information than provided in the loan application.

As part of the Review/Additional Underwriting step 122, the system uses the scoring results to evaluate the application by comparing it to a user-defined Decision Engine 121. The Decision Engine 121 then forwards the loan application to one of five tracking classifications: Automatic Approval 124, Approved Pending Verification 126, Review/Additional Underwriting Required 122, Automatic Decline 128 and Decline Pending Verification of Data 130.

The financial institution establishes parameters that are placed in the Decision Engine 121 against which the loan application data is compared. These parameters include the type of potential loan to be granted, the requested amount of the loan, the purpose of the loan (working capital, equipment purchase, inventory financing), and the type of obligor, among other factors. Depending upon the parameters, the application is then routed to the various tracking classifications. For example an application that was credit scored, received a score within certain positive range, and met all other required criteria would be forwarded to the Auto Approval 124 track.

The institution's customers are appropriately notified and those loans ready for closing proceed to the Closing module 26 which repeats the closing steps described in above in connection with the Closing module 26, FIG. 3A,.

Those loan applications that are suspected as fraudulent due to misrepresentation of loan application data submitted by the prospective borrower are analyzed in the Fraud Suspect module 134. Loan applications suspected of fraud are transmitted through the Fraud Suspect module 134 fraud identification service. If no flags for suspected fraud are found, then the loan application is forwarded to the score/no score decision engine and proceeds forward.

All of the small business and consumer loans, once closed, also have the documentation reviewed for completeness. Exceptions are also noted on the documentation and then the documentation is filed. The booking of the loan itself is completed through the Loan Accounting & Processing component 14 regardless of the type of loan. Note exceptions are forwarded to the Portfolio Management component 16 where the exception database 52 generates reminders and reports in order to resolve the open documentation issues.

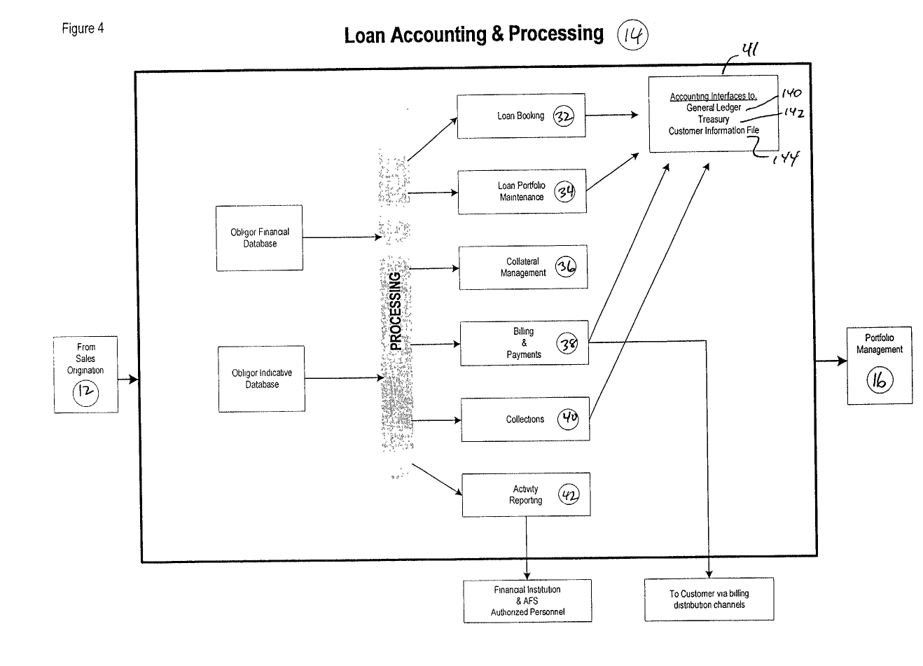

FIG. 4 is a more detailed diagrammatic depiction of the Loan Accounting and Processing component 14. Information consisting of indicative data (name, address, social security number, etc.) and financial information (the amount of the loan, the type, the interest rate, fees etc.) are all loaded into the process via the Sales Origination component 12. Financial data entered into the process can relate either to new loans or existing obligations.

Within the Loan Accounting & Processing Process component 14 data is categorized. Data within the Loan Accounting & Processing system falls within two major categories: indicative and financial. Indicative information is the name, address, social security number, etc. of all obligors. Obligors are any legal entities doing business with the financial institution including, but not limited to, borrowers, dealers, collateral owners, guarantors. Financial information consists of the components of the loan such as the amount of the loan, the type, the interest rate, fees, etc. Both the indicative and financial data are compartmentalized and interconnected so that as the system is called upon to create a bill, record a loan payment, generate a payoff statement, change the interest rate, etc. the activity is accomplished efficiently and affects all the appropriate affiliated activities. For example, when a loan payment is received, the system not only reduces the amount of the principal and interest outstanding, but also sends a message to the financial institution's General Ledger system. The system also reduces “billing buckets” which track amounts billed and not paid, affects aging records which show how old unpaid amounts are, and it updates histories of principal and interest activity.

Depending on the activity required, appropriate elements of data are drawn from the database to calculate or further develop the information needed. Because the database is designed to accommodate a wide array of information, the process is capable of managing all of the following modules: Loan Booking 32, Loan Portfolio Maintenance 34, Collateral Management 36, Billing & Payment applications 38, Collections 40, and Activity Reporting 42.

The Activity Reporting module 42 are generated for the use by the financial institution and AFS authorized staff to monitor the loan activity and assure the process is running correctly.

As with the Sales Origination component 12, two-way Accounting Interfaces 41 exist adapted to communicate with the financial institution's internal processes such as General Ledger 140, Treasury 142, and Customer Information Files 144 from the Loan Accounting & Processing component 14. The loan process's flexibility is such that it is capable of sending only that data which is required to keep the financial institution's servers updated on a daily basis. Unlike known processes, the Loan Accounting & Processing component 14 of the present invention is able to directly generate bills to the institution's clients.

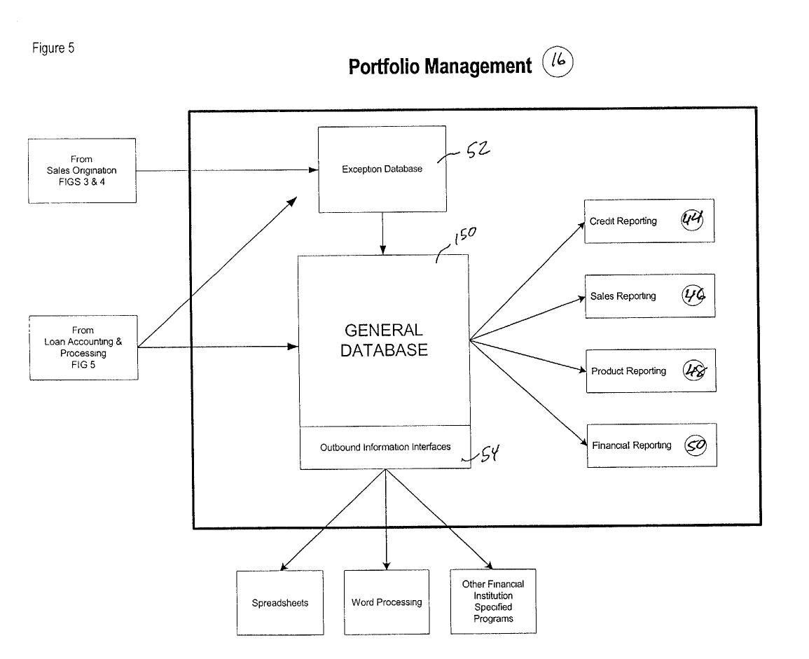

FIGS. 2-4 have represented all of the activities necessary to originate and maintain a loan portfolio. The present invention enables a financial institution to service loans and loan customer without any further processes or technology. However, if the management of the organization is to keep the institution running profitably, determine whether any revenue leakage has occurred, and evaluate and recognize areas of opportunity to create new products, then further information must be provided. This type of information is not easily captured simply by downloading loan data onto spreadsheets. Capturing, manipulating and presenting loan portfolio data in a multidimensional structure requires sophisticated processes and technology. The Portfolio Management Process component (FIG. 1, 4) (FIG. 5) provides the means for accomplishing these goals.

FIG. 5 is a diagrammatic representation of the Portfolio Management Process component. Data from the Sales Origination 2 and Loan Accounting & Processing Process 3 components are transmitted to two databases within the Portfolio Management Process 4. The Exception Database 52 captures all of the electronically noted exceptions that have occurred during the loan origination and management process. Examples of such exceptions include: documents which were required for loan closing that omit a date or signature, loans which are placed in non-performing or non-accrual categories, covenants in loan agreements which have not been met, and differences in interest rate actually charged versus that which was approved. Loan exception information can become the subject of individual reports, or can be incorporated into management reports generated so that corrective steps can be taken.

The General Database 150 extracts loan data from the Loan Accounting & Processing component 14 and manipulates the data to provide in-depth information about the condition of and activities in the institution's overall portfolio. Capability exists to drilldown to determine within geographic area the type of loans being granted, number of loans, degree of rate exceptions, etc. Similarly management can view the information from the perspective of loan type. This information is accessed by the financial institution by calling up computer programs focused on specific issues.

Credit Reporting 44 focuses on credit quality reporting. Credit Reporting 44 collects information for portfolio and line managers, credit review staff and others to monitor credit problems, track industry exposure, and understand risk migration patterns. Reports can be generated based upon the information collected. This report also draws on information taken from the Exception Database 52 which connects to the General Database 150 on an as-needed basis.

Sales Reporting 46 provides report information for managers who determine sales efforts, support cross selling activities, develop officer incentives, and improve customer profitability.

Product Reporting 48 displays loan products that have been extended and helps managers optimize price and revenue from loan product lines.

Financial Reporting 50 provides information about loan rates that have been extended, fees charged and other data that impacts the revenue of the financial institution.

The Portfolio Management component 16 also has Outbound Information Interface 54 capability. Often, reports such as those created by Portfolio Management component 16 will be incorporated into internal and external financial institution documents accompanied by data about other areas of the institution. To do that, the institution must have the ability to place the data into word processing, spreadsheet and imaging and other formats. The Outbound Information Interface 54 allows exportation of the data in useable formats.

The three components of the process of the present invention, linked together via the network infrastructure described above, create a broad and complete array of essential tools for financial institution operation and management. It is this combination of information gathering, calculating, manipulating, and reporting capabilities combined with the application server delivery methodology that makes the present invention unique.

What is claimed is:

1. An automated and integrated loan processing system, comprising:
a) a sales origination component;
b) a loan accounting and processing component; and,
c) portfolio management component.

2. The automated and integrated loan processing system of claim 1, further comprising a network infrastructure utilizing thin client workstations and multiple servers to access the automated and integrated loan processing system.

3. A method of processing a loan using an automated and integrated system, comprising:
a) obtaining loan application information from a borrower;
b) entering loan application information into a sales origination component;
c) exchanging information regarding a loan application with a loan accounting and processing component;
d) forming a loan record;
e) forwarding the loan record to the loan accounting and processing component;
f) forwarding the loan record to a portfolio management component.
